(19) United States
(12) Patent Application Publication
(10) Pub. No.: US 2026/0039772 A1
(43) Pub. Date: Feb. 5, 2026

(54) Remote Event Monitoring System and Method

(71) Applicant: Tooth Care Project Ltd., Weston Super Mare (GB)

(72) Inventors: Simon Jackson, Greater London, London (GB); Paul Dack, Greater London, London (GB); Petrus Hendrik Bezuidenhout, Greater London, London (GB); Autumn Danks, Greater London, London (GB)

(73) Assignee: Tooth Care Project Ltd., Weston Super Mare (GB)

(21) Appl. No.: 19/099,113

(22) PCT Filed: Jul. 28, 2023
(86) PCT No.: PCT/GB2023/052002

§ 371 Date: Jan. 28, 2025

(30) Foreign Application Priority Data
Jul. 28, 2022 (GB) 2211042.3

(51) Int. Cl. H04N 7/18; G06V 20/52; H04N 5/77; H04N 23/60; H04N 23/62; H04R 1/02

(52) U.S. Cl. CPC H04N 7/183; G06V 20/52; H04N 5/772; H04N 23/62; H04N 23/64; H04R 1/028; H04R 2499/11

(57) ABSTRACT

An event monitoring system comprises a wireless camera module and a remote electronic device for monitoring one or more events recorded by the camera module. The camera module comprises a user actuable input device and a digital image and/or video recording device and is arranged to: in response to user actuation of the input device, set a timer for a predetermined period; at intervals during the predetermined period for monitoring an event, record a plurality of digital images and/or video clips using the digital image and/or video recording device; store data relating to the event, the data including the recorded plurality of digital images and/or video clips; and transmit the data relating to the event to the remote device over the wireless connection for monitoring by the remote device. The system may be used for monitoring occurrence and correct performance of a task such as toothbrushing or homework.

### FIELD OF THE INVENTION

The present invention relates to system and method for remote monitoring of an event, particularly but not exclusively for monitoring correct performance of a task such as toothbrushing.

### BACKGROUND OF THE INVENTION

It is recommended by the UK National Health Service and the American Dental Association to brush one's teeth twice daily, for 2 minutes. Children often find this onerous and may avoid doing so, with potential impact on their dental health. There is therefore a need to monitor the frequency and/or duration of toothbrushing, so that parents or carers can ensure that children are brushing their teeth correctly. It is impractical and may be intrusive for the parent or carer to be physically present on each occasion.

Various technical measures have been proposed for monitoring toothbrushing, but these typically involve a modified toothbrush that records and/or reports activity. For example, WO-A-02/83257 discloses a toothbrush with a position sensor, the output of which is transmitted to a data analysis unit as a wireless signal.

Known monitoring systems typically require complex equipment and may be vulnerable to cheating, for example by children who prefer to simulate toothbrushing even if this takes the same amount of time and effort as proper toothbrushing, just for the satisfaction of beating the system. It would be advantageous to provide a monitoring system that is straightforward to implement and resistant to cheating.

Similar problems may arise in other contexts, such as remote monitoring of a child performing homework, or invigilation of a candidate sitting an exam.

It would also be desirable to incentivise a child to perform toothbrush or homework correctly and regularly.

### STATEMENTS OF THE INVENTION

Aspects of the invention are defined by the accompanying claims.

An embodiment of the invention comprises a wireless camera module having a user actuable input device and a digital image and/or video recording device. In a mode of operation, the camera module sets a timer for a predetermined period of monitoring an event in response to user actuation of the input device. At intervals during the predetermined period, the camera module records a plurality of digital images and/or video clips. Preferably after the predetermined period, the camera module transmits the recorded images/clips over the wireless connection. The remote device can then be used to monitor an event that occurred during the predetermined period, such as toothbrushing or homework.

Advantageously, the camera module provides a convenient device for monitoring the event that is still under the control of the person being monitored, because recording is only activated for a predetermined period after actuation of the input device. Preferably, the camera module includes an indicator that indicates that the camera module is active during the predetermined period.

Recording at intervals reduces the amount of data that needs to be recorded, instead of recording continuously throughout the predetermined period. Advantageously, the intervals are set randomly or pseudo-randomly throughout the predetermined period, so that the person being monitored does not know or cannot easily predict when recording is taking place or is about to take place, and is therefore likely to perform a task correctly throughout the period. The recording intervals or times may be set randomly or pseudo-randomly by a random or pseudo-random number generator within or connected to the camera module (rather than, for example, being triggered by an event detected by the digital recording device).

Each recording may be made at a randomly or pseudo-randomly determined time within a respective predetermined subdivision of the predetermined period. The subdivisions may correspond to different expected phases of the event to be monitored, such as brushing of different quadrants of the teeth. In this way, each expected phase may be monitored. The camera module may indicate which phase is currently expected, for example by giving a different indication to the user for each quadrant of the teeth.

The transmission of data may be initiated by further actuation of the input device, or automatically when the wireless connection is active. The wireless connection may be a local wireless connection such as a Bluetooth(®) connection, or a wireless connection to a remote server. The data is preferably transmitted securely, to reduce the security risk of remote hacking of the camera module.

The remote electronic device may be a smartphone running an app for checking monitored events. For example, the app may check the frequency of monitored events, such as whether they occur twice a day in the case of toothbrushing, or once every evening during the week in the case of homework. The app may display the recorded images and/or video clips associated with an event so that a user of the remote device can check for the desired activity during a monitored event, such as toothbrushing or doing homework. Alternatively, the app may analyse the images and/or video clips for the desired activity, or the analysis may be performed by a remote service, for example using a machine learning model trained to identify the desired activity. The app may enable one or more actions depending on compliance with the desired activity.

### BRIEF DESCRIPTION OF THE DRAWINGS

There now follows, by way of example only, a detailed description of embodiments of the present invention, with reference to the figures identified below.

FIG. 1 is a schematic diagram of a monitoring system in an embodiment of the invention.

FIG. 2 is a schematic diagram of components of a camera module of the monitoring system in a first embodiment.

FIG. 3 is a schematic diagram showing the location of components within the camera module of the first embodiment.

FIG. 4 is a perspective view of a camera module of the monitoring system in a second embodiment.

FIG. 5 is an exploded view of the camera module in the second embodiment.

FIG. 6 is a flowchart of the operation of the monitoring system.

FIGS. 7a-7f are examples of screen displays of an app providing a user interface to the monitoring system.

FIG. 8 is a schematic diagram of an example of a computing device on which one or more of the functions of the embodiments may be implemented.

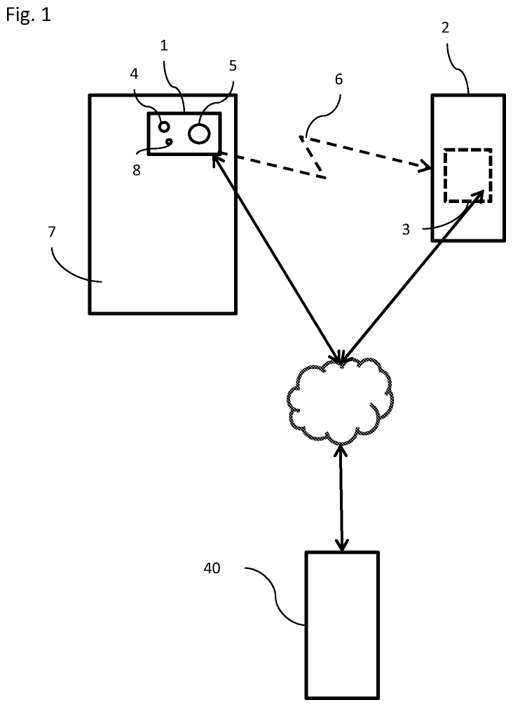

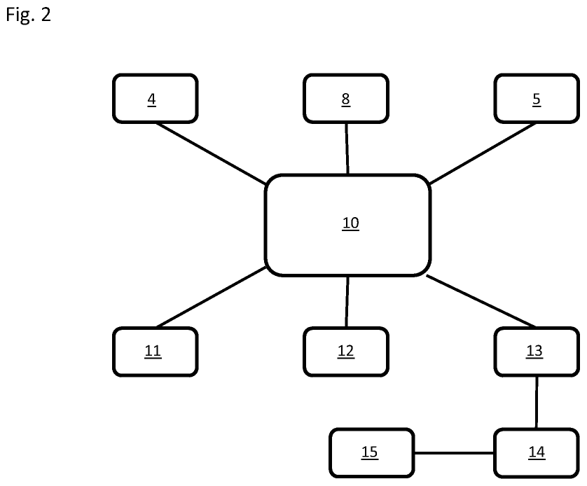

### DETAILED DESCRIPTION

The event monitoring system in the embodiment comprises a camera module 1 including a camera 4 and a press button 5, switch or other user actuable input device which may be integrated within the camera module 1. The camera module 1 may be attached to a surface 7, such as a mirror in a bathroom. Preferably, the camera 4 is a wide-angle camera suitable for imaging a face when in proximity to the surface 7 such as during toothbrushing. There may be provided a removable lens cover for the camera 4, to provide user control over recording by the camera 4.

The camera module 1 is in wireless communication, directly or indirectly with an electronic device 2 such as a smartphone or other mobile electronic device running a software application or app 3. The wireless connection 6 may be a direct connection such as a Bluetooth(®) connection, or a network connection such as a Wi-Fi(®) connection.

Alternatively or additionally, the camera module 1 and the electronic device 2 may connect to a local or remote server 40 via a local network, such as a Wi-Fi(®) network, and/or via a remote network such as the Internet. Functionality of the monitoring system may be divided between the server 40 and the electronic device 2, with the electronic device 2 providing a user interface to a user via the app 3. Data is preferably transferred securely, such as with a TLS connection.

The camera module 1 includes an electronic microcontroller 10 or processor that controls the operation of the camera module 1 and its components, including the camera 4 and an LED (light emitting diode) 8 or other indicator, preferably by means of a computer program comprising instructions to perform a sequence of operations, such as the method of operation described below.

The microcontroller 10 receives an input from the push button 5. The microcontroller 10 may include an integral wireless interface, which is connected to an antenna 11. Alternatively, a discrete wireless interface may be used. The microcontroller 10 stores data, including digital photographs or video clips from the camera 4, on a memory 12 such as an SD (secure digital) card. The microcontroller 10, and other components requiring electrical power, receive power from a rechargeable battery 13, such as a lithium battery. The battery 13 may be rechargeable by means of a charging circuit 14 removably connected to a power supply 15, such as via a USB charging cable or a wireless charger.

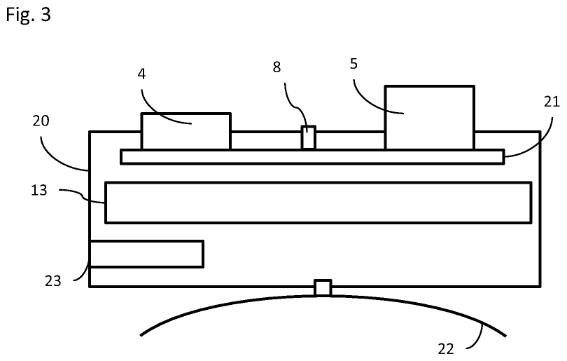

As shown in FIG. 3, the components of the camera module 1 in a first embodiment are arranged within a housing 20. The microcontroller 10, camera 4, push button 5 and LED 8 are mounted on a printed circuit board (PCB) 21 within the housing 20 and project through apertures in the front surface of the housing 20. The rechargeable battery 13 is positioned under, and connected to the PCB 21. A charging port 23, for an electrical charging connection to the rechargeable battery 13, is located in one side of the housing 20.

A suction cup, or other attachment means 22, is provided on the rear face of the housing 20 for attaching the camera module to the surface. Alternative attachment means may include a hook and loop fastener, or a hook for hanging on the upper edge of a mirror. Alternatively the camera module 1 may be attached to the surface 7 by adhesive.

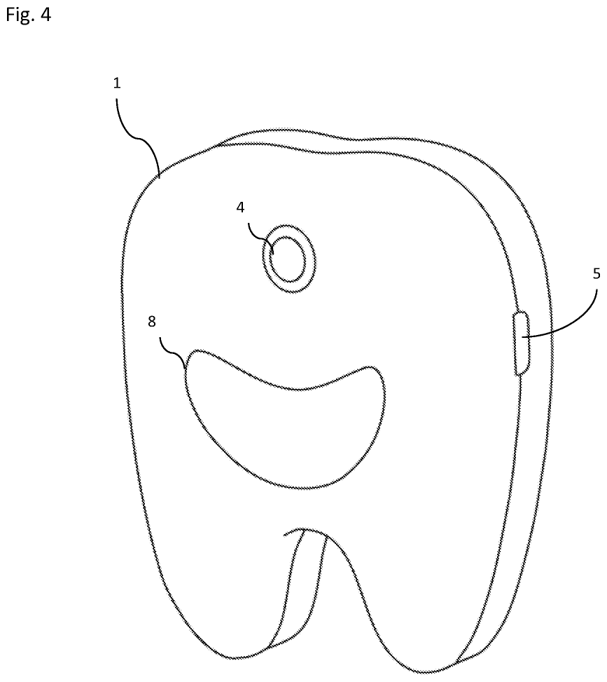

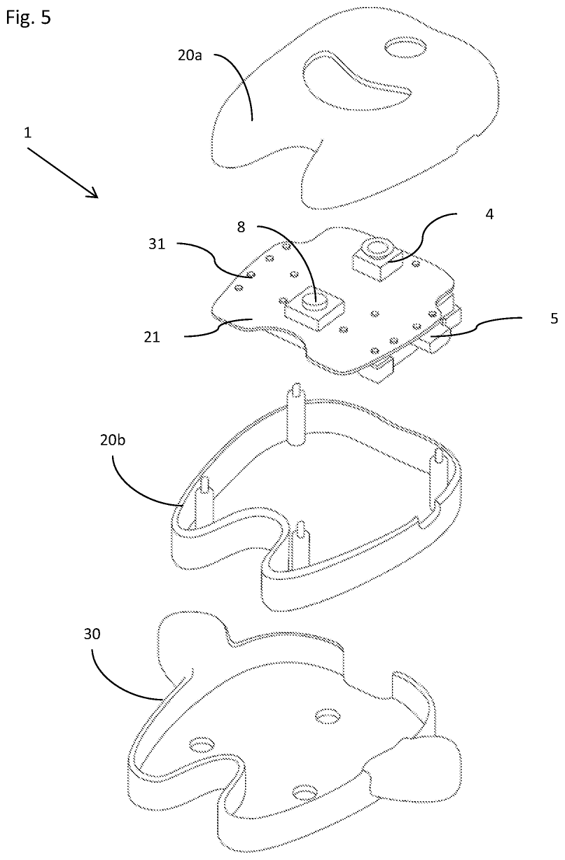

FIGS. 4 and 5 show the camera module 1 in a second embodiment, which is similar to the first embodiment but with additional features as described below. The housing 20 comprises front and rear housing portions 20a, 20b which are fixed together with the PCB 21 housed within.

The housing 20 in this embodiment has the shape of a tooth, but other shapes may be used depending on the intended use and attractiveness to the user. The housing 20 is removably insertable in a holder 30, which may be attached to the surface 7 by the attachment means 22. This allows the housing 20 to be removed from the holder 30, for example for recharging the battery 13, without the need to remove the holder 30 from the surface 7. In another embodiment, any one of a plurality of different skins, facades or external decorations may be attached to the housing 20 so as to customise its appearance.

In this embodiment, the PCB 21 includes a plurality of additional LEDs 31 on the front surface thereof, which illuminate the front housing 20a to provide additional indications visible to a user, as described further below.

In an alternative embodiment, the push button 5 may be replaced by another form of user input, not necessarily integrated within the camera module 1. For example, an electric toothbrush may have a wireless (e.g. Bluetooth(®)) connection to the camera module 1 such that switching on the electric toothbrush causes a signal to be sent to the camera module 1 so as to initiate a specific monitoring session.

A method of operation of the system will now be described. First, the operator of the electronic device 2 creates an account using the app 3 and pairs the camera module 1 with the account, for example by interaction with the server 40. Pairing may be initiated by a long press of the button 5.

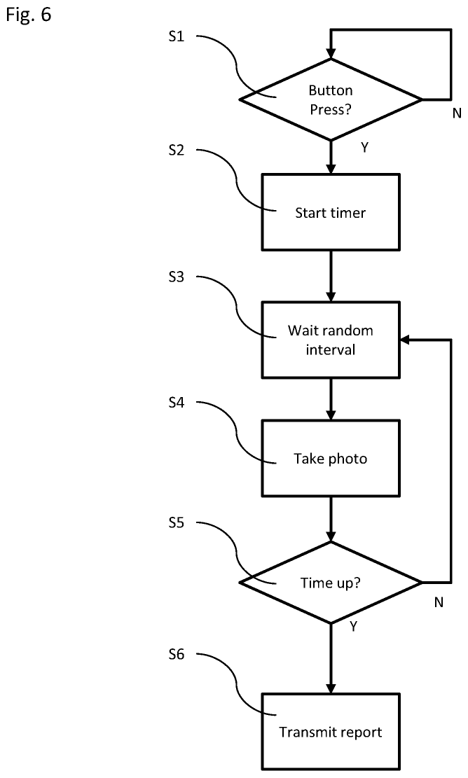

The operation of a specific monitoring session will now be described with reference to FIG. 6, in the context of monitoring tooth brushing by a child for a predetermined period, such as two minutes. When or before the child starts brushing, the child presses the button 5 or provides some other input as described above to start a monitoring session (step S1). In response to the user input, the microcontroller 10 starts a first timer set to the predetermined period, such as two minutes. During that period, the microcontroller 10 may activate the LED 8 and/or provide some other indication (e.g. audio output) that monitoring is taking place.

During the predetermined period, the microcontroller 10 activates the camera 4 to take a photo and/or video clip at each of a plurality of points in time, spaced by random or pseudo-random intervals (steps S3, S4) so that the child does not know precisely when the photo/video clip will be taken and therefore cannot pose with the toothbrush in the correct position so as to cheat the monitoring system.

The points in time may be determined at the beginning of the monitoring session, or the microcontroller may set a second timer for a random or pseudo-random interval, preferably within a predetermined range such as 10-20 seconds.

After the interval set for the second timer has expired, the microcontroller 10 activates the camera 4 to take a photo and/or video clip and the second timer is reset so as to determine the random or pseudo-random interval until the next activation of the camera 4.

The plurality of points in time may be set within a series of predetermined subdivisions of the predetermined period, for example corresponding to different phases of brushing. For example, each subdivision may be a sequential 30 second period so that there are four subdivisions corresponding to the four quadrants of the teeth (upper/lower, right/left). An alternative number and length of subdivisions may be used, depending on the desired tooth brushing technique. The current phase may be indicated to the child by means of the LED 8 and/or the additional LEDs 31, for example by illuminating a quadrant of the front housing portion 20a corresponding to the quadrant of the teeth that is to be brushed.

The camera module 1 may include audio functionality (e.g. once or more speakers and audio generating circuits) so as to generate music and/or speech before, during and/or after each session: for example, instructions on correct brushing including optionally an explanation of the current phase of brushing, and music to entertain the child during brushing.

The camera module 1 should be positioned so that the photos or video clips should show the child brushing his/her teeth, if that is indeed what is happening during that period. The photos and/or video clips are stored in the memory 12.

When the microcontroller 10 determines that the period has expired (step S5), it indicates this to the child, for example using the LED 8 and/or additional LEDs 31 and saves a log or report of the monitoring session, such as start time, period of monitoring, and the photos and/or video clips associated with the monitoring session.

The camera module 1 transmits the log (Step S6) over the wireless connection 6 to the app 3 on the mobile device 2, and/or to the server 40. The transmission may be initiated automatically, or by a long press of the push button 5, for example by a supervisor. The log includes data indicating that a monitoring session was completed, and preferably including some or all of the photos and/or video clips recorded during the period of the monitoring session. When the log has been successfully received, the app 3 may generate a notification for the user (e.g. parent) to review the session so as to approve or reject it as described below.

Preferably, in order to reduce the memory requirements of the camera module 1, the log is automatically transmitted to the server 40 after each session. The camera module 1 then enters a low-power sleep mode until activated again, for example by pressing the button 5. By conserving power, the camera module 1 may be powered by a low-power rechargeable battery, such as an internal single-cell lithium battery with a capacity of 1500 mAh capacity, with a target battery life of 1 month for 2 sessions of 2 minutes a day with 30 seconds upload time after each session.

The app 3 or server 40 stores the received logs and may perform various different functions based on that log. For example, the app 3 or server 40 may check whether it has received two reports of monitoring sessions in a particular day and if not, may provide a notification to the user. Alternatively or additionally, the app 3 or server 40 may take one or more predetermined actions, such as deducting an amount from a payment to be made to the child i.e. a fine from the child's allowance. The app 3 or server 40 may alternatively or additionally provide a positive reward to the child for correct brushing, such as making a payment or providing additional screen time.

The app 3 may allow the user of the app 3 to view the set of images from a specified monitoring session so as to determine whether tooth brushing was taking place during that session. Alternatively or additionally, the app 3 or server 40 may analyse the photos and/or video clips, or send the photos and/or video clips to a remote analysis facility, to determine whether tooth brushing was taking place during that session, for example using a machine learning model that has been trained to identify correct toothbrushing from digital images or video clips. In one example, the machine learning model may be trained with the user inputs indicating whether toothbrushing was taking place in the corresponding images. Hence, the user of the app 3 need not review every set of images but may only be prompted for a ser input where the machine learning model does not produce an indication of whether toothbrushing was taking place, with sufficiently high confidence. In this way, the need to prompt the user to identify correct toothbrushing may progressively diminish.

The photos and/or video clips (i.e. images) may be processed by the camera module 1 before transmission from the camera module 1 and/or by the server 40 and/or app 3 on reception. The processing may include compression by the camera module 1 so as to reduce the amount of data that needs to be transmitted. The processing may include removal of extraneous material that might compromise the privacy of the subject, such as removal of the background and/or replacement of the face with a processed version or avatar such that the face is no longer recognisable, although the avatar may be recognisable by a parent as one representing the child.

The processing may include facial recognition so as to identify the child in the image(s). This may be used so as to automatically differentiate between multiple users, and/or to verify that a registered child and not a substitute is performing the toothbrushing.

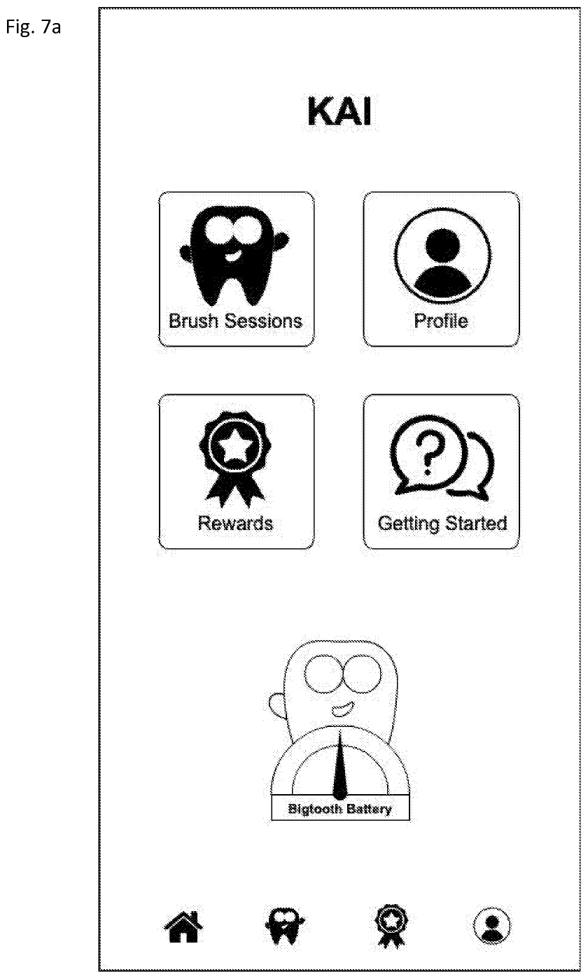

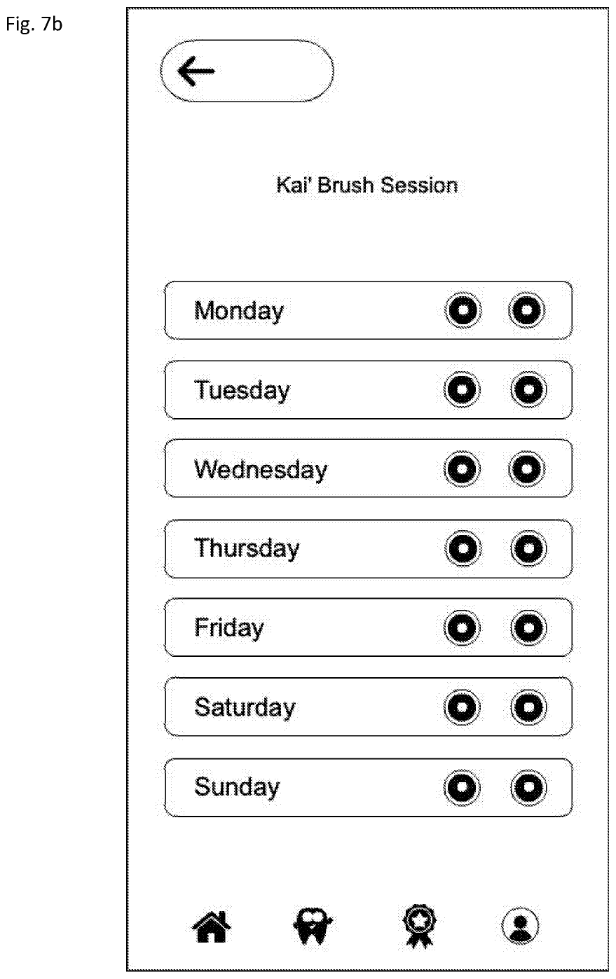

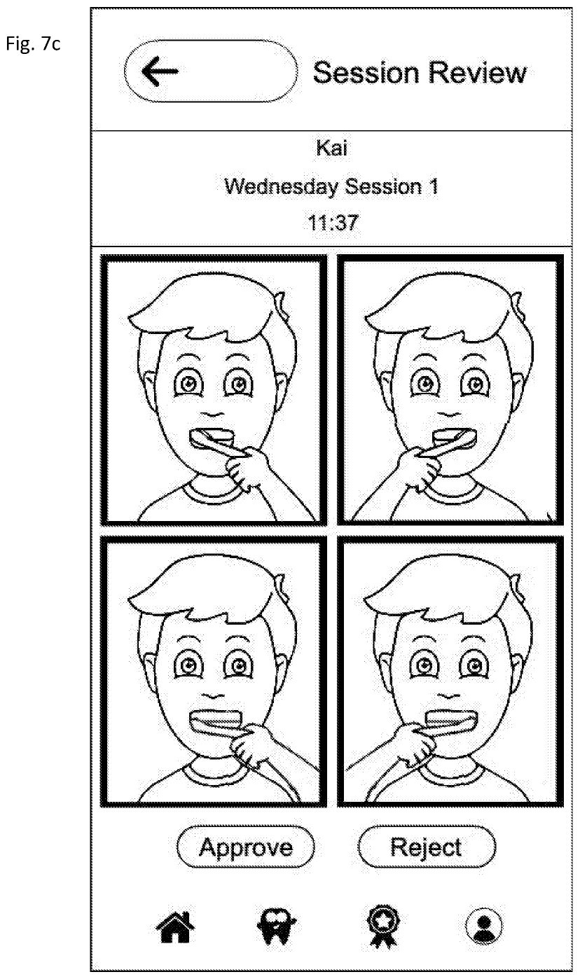

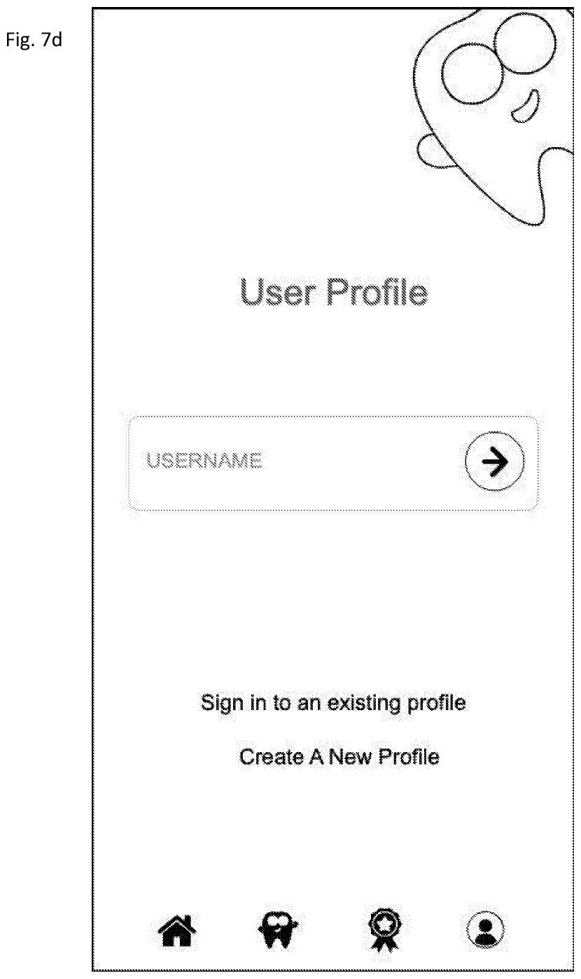

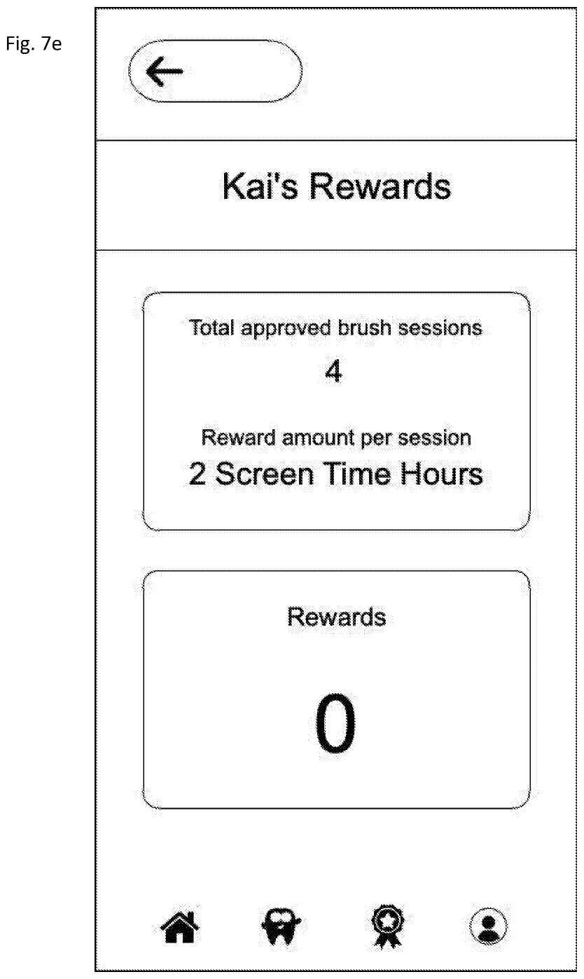

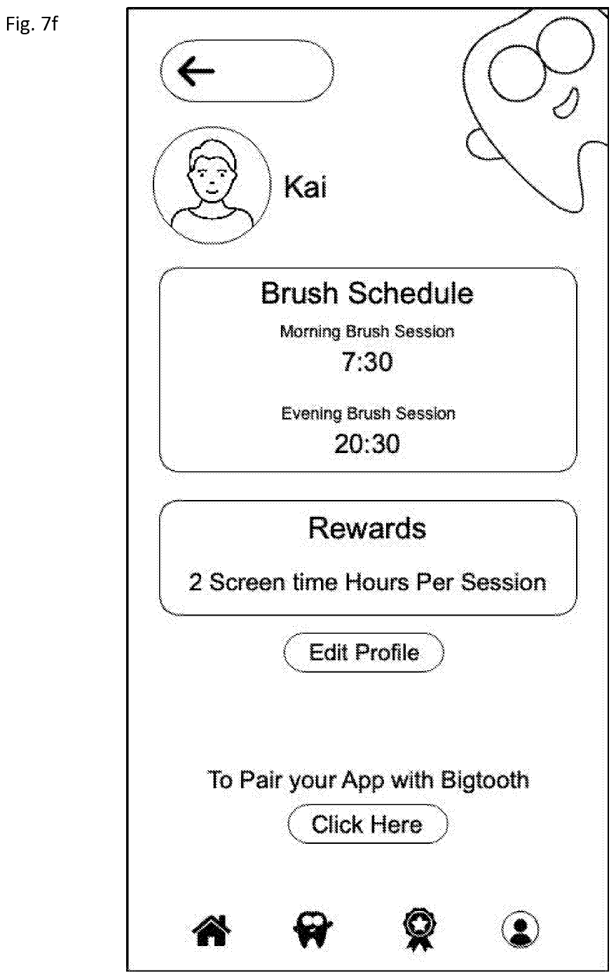

FIGS. 7a-7f show examples of screens generated by the app 3 on the mobile device 2 to implement different functions of the monitoring system. FIG. 7a shows a home screen for a child ('Kai') with icons for Brush Sessions, Profile, Rewards and Getting Started. The home screen also includes an indicator of the child's tooth brushing performance, in this case on a scale of red (poor) to green (good).

FIG. 7b shows a Brush Sessions screen, displayed in response to selecting the Brush Sessions icon. This screen indicates whether a session has been recorded for each of morning and evening for each day of the week in the current week, and whether that session has been approved or rejected.

In response to selecting an indicator for a recorded session, the images for that session are displayed in a Session Review screen, as shown for example in FIG. 7c. The user of the app 3 views the images for that session and may select to approve or reject the session.

FIG. 7d shows a user profile screen displayed in response to selection of the Profile icon. One or more profiles may be selected from this screen; in this case a single profile has been created for the child Kai. The display of the other screens relates to the profile currently selected.

FIG. 7e shows a Rewards screen indicating the child's performance and rewards given based on that performance. In this case, the child has 4 approved sessions and is awarded 2 hours of screen time per session.

FIG. 7f shows profile settings for the current profile, as selected from the User Profile screen. The profile settings may include the timing of the sessions: in this example, the user may set times by which the morning and evening sessions must be completed in order to be recorded. The profile settings may include a reward setting determining what award is given for a specified number and/or frequency of approved sessions. The profile settings screen also allows the user of the app 3 to log in to the monitoring system.

The app 3 may be used to configure other settings such as the length of the predetermined period of the monitoring session, the number of subdivisions of each monitoring session and/or the number of photos/video clips to be taken per session.

### Computer System

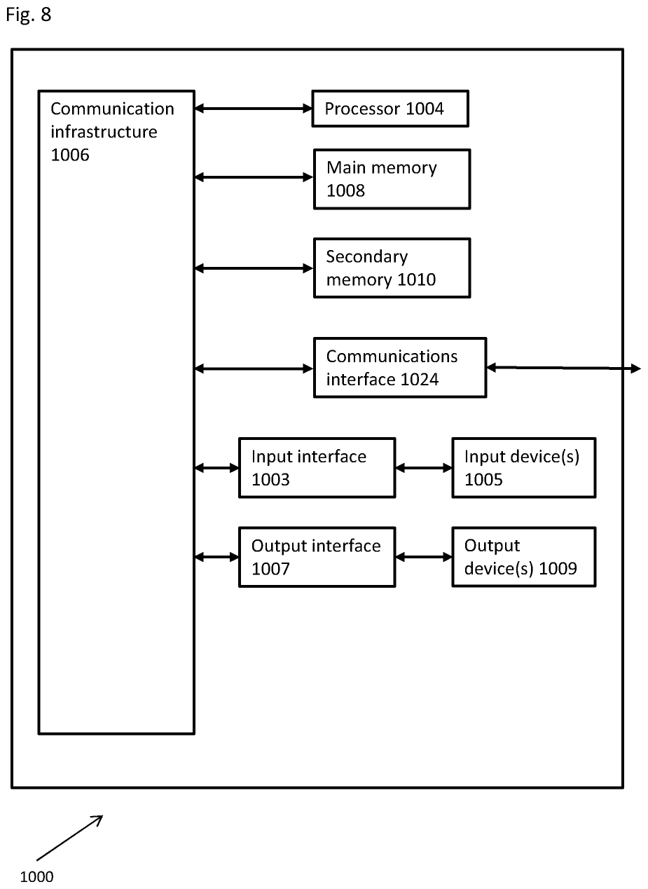

FIG. 8 illustrates an example computer system 1000 in which embodiments of the present invention, or portions thereof, can be implemented as computer-readable code to program processing components of the computer system 1000. Various embodiments of the invention are described in terms of this example computer system 1000. For example, the camera module 1, electronic device 2 and/or the server 40 can each be implemented as a computer system such as system 1000. The method illustrated by the flowchart of FIG. 6 can be implemented in system 1000. After reading this description, it will become apparent to a person skilled in the relevant art how to implement the invention using other computer systems and/or computer architectures.

Computer system 1000 includes one or more processors, such as processor 1004. Processor 1004 can be a special purpose or a general-purpose processor. Processor 1004 is connected to a communication infrastructure 1006 (for example, a bus, or network). Computer system 1000 may include includes a user input interface 1003 connected to one or more input device(s) 1005 and a output interface 1007 connected to one or more output devices 1009, which may be integrated input and display components. Input devices 1005 may include, for example, a connected device such as a mouse or touchpad, a keyboard, a touchscreen such as a resistive or capacitive touchscreen, etc.

Computer system 1000 also includes a main memory 1008, preferably random access memory (RAM), and may also include a secondary memory 1010. Secondary memory 1010 may include, for example, a hard disk drive, a removable storage drive, flash memory, a memory stick, and/or any similar non-volatile storage mechanism. As will be appreciated by persons skilled in the relevant art(s), removable storage may include a non-transitory computer usable storage medium having stored therein computer software and/or data.

In alternative implementations, secondary memory 1010 may include other similar means for allowing computer programs or other instructions to be loaded into computer system 1000. Such means may include, for example, a removable storage unit and an interface which allow software and data to be transferred from the removable storage unit to computer system 1000.

Computer system 1000 may also include a communications interface 1024 implemented for example at the operating system level to allow data to be transferred between computer system 1000 and external devices, for example as signals over a communication channel. Communications interface 1024 may include a modem, a network interface (such as an Ethernet card), a communications port, a PCMCIA slot and card, or the like.

Various aspects of the present invention, such as app 3, may be implemented by software and/or firmware (also called computer programs, instructions or computer control logic) to program programmable hardware, or hardware including special-purpose hardwired circuits such as application-specific integrated circuits (ASICs), programmable logic devices (PLDs), field-programmable gate arrays (FPGAs), etc. of the computer system 1000, or a combination thereof. Computer programs for use in implementing the techniques introduced here may be stored on a machine-readable storage medium and may be executed by one or more general-purpose or special-purpose programmable microprocessors. The terms “computer program medium”, “non-transitory computer readable medium” and “computer usable medium” introduced herein can generally refer to media such as removable storage unit, removable storage unit, and a hard disk installed in hard disk drive. Computer program medium, computer readable storage medium, and computer usable medium can also refer to memories, such as main memory 1008 and secondary memory 1010, which can be memory semiconductors (e.g. DRAMs, etc.). These computer program products are means for providing software to computer system 1000.

Computer programs are stored in main memory 1008 and/or secondary memory 1010. Computer programs may also be received via communications interface 1024. Such computer programs, when executed, enable computer system 1000 to implement the present invention as described herein. In particular, the computer programs, when executed, enable processor 1004 to implement the processes of embodiments of the present invention as described above. Accordingly, such computer programs represent controllers of the computer system 1000. Where the invention is implemented using software, the software may be stored in a computer program product and loaded into computer system 1000 using removable storage or communications interface 1024.

### Alternative Embodiments

The monitoring system may alternatively or additionally be applied to monitoring of other activities. For example, the monitoring system may be used to monitor homework by a child, with the predetermined period being set to a value suitable for homework e.g. 30 5 minutes or 1 hour, with suitable subdivisions such as 5 minutes to ensure that the child is working throughout the predetermined period. The monitoring system could be used for invigilation of an examination over the predetermined period.

Variants of the above embodiments, which may occur to the skilled person on reading the above description, may nevertheless fall within the scope of the invention as defined by the following claims.

1. Event monitoring apparatus comprising a wireless camera module having a wireless connection, the camera module comprising a digital image and/or video recording device and a user actuable input device; wherein the camera module is arranged to:
a) in response to user actuation of the input device, set a timer for a predetermined period for monitoring an event;
b) record a plurality of digital images and/or video clips at respective times during the predetermined period, using the digital image and/or video recording device;
c) store data relating to the event, the data including the recorded plurality of digital images and/or video clips; and
d) transmit the data relating to the event over the wireless connection for monitoring by a remote device.

2. The apparatus of claim 1, wherein the times at which the digital images and/or video clips are recorded are randomly or pseudo-randomly determined.

3. The apparatus of claim 2, wherein the digital images and/or video clips are each recorded at a randomly or pseudo-randomly determined time within a respective predetermined subdivision of the predetermined period.

4. The apparatus of claim 1, wherein the data is transmitted in response to a further actuation of the input device.

5. The apparatus of claim 1, wherein the data is transmitted automatically after the predetermined period.

6. The apparatus of claim 1, wherein the camera module includes an indicator arranged to indicate that the camera module is active during the predetermined period.

7. The apparatus of claim 6, wherein the indicator is arranged to indicate the-predetermined subdivisions of the predetermined period.

8. The apparatus of claim 1, wherein the input device and recording device are integrated in the camera module.

9. The apparatus of claim 1, wherein the input device is wirelessly connected or connectable to the camera module.

10. The apparatus of claim 8, wherein the camera module includes means for attaching the camera module to a surface.

11. The apparatus of claim 1, wherein the camera module includes a rechargeable battery for providing electrical power for operation of the camera module.

12. The apparatus of claim 1, wherein the camera module includes an audio output device arranged to output audio to the user during the event.

13. (canceled)

14. The system of claim 1, wherein the remote device includes a software application arranged to access the data relating to the event.

15. The system of claim 14, wherein the software application is arranged to indicate to a user of the remote device the occurrence of events monitored by the camera module.

16. The system of claim 14, wherein the software application is arranged to display to a user of the remote device the recorded plurality of digital images and/or video clips and to receive input from the user indicating compliance with an expected activity during the associated event.

17. The system of claim 14, wherein the software application is arranged to analyse, or send for remote analysis, the recorded plurality of digital images and/or video clips for compliance with an expected activity during the associated event.

18. The system of claim 17, including a machine learning model arranged to analyse the recorded plurality of digital images and/or video clips for compliance with an expected activity during the associated event.

19. The system of claim 17, wherein the machine learning model is trained using the input from the user indicating compliance with an expected activity during the associated event.

20. The system of claim 14, wherein the software application is arranged to enable a reward in response to the occurrence of events monitored by the camera module which comply with an expected activity during the associated event.

21. The system of claim 14, wherein the software application is arranged to configure the operation of the camera module via the wireless connection.

22. (canceled)

23. (canceled)

24. (canceled)
